(19) United States
(12) Patent Application Publication
(10) Pub. No.: US 2022/0141582 A1
(43) Pub. Date: May 5, 2022

(54) MICROPHONE ARRAY DEVICE

(71) Applicants: Audio-Technica Corporation, Tokyo (JP); NHK Technologies, Inc., Tokyo (JP)

(72) Inventors: Shioto OKITA, Tokyo (JP); Yusuke SANO, Tokyo (JP); Akifumi YAMAGUCHI, Tokyo (JP); Katsuhisa IDA, Tokyo (JP)

(21) Appl. No.: 17/507,228

(22) Filed: Oct. 21, 2021

(30) Foreign Application Priority Data
Oct. 30, 2020 (JP) 2020-182402

(51) Int. Cl. H04R 3/00; H04R 1/32

(52) U.S. Cl. CPC H04R 3/005; H04R 1/326

(57) ABSTRACT

Provided is a microphone array device that is excellent in portability and suppresses sound wave interference.

A microphone array device 1 according to the present invention includes a plurality of microphones and a housing 10 that accommodates the microphones. The housing includes first, second, third and fourth holes opened to an end surface of the housing in +X-axis, −X-axis, +Y-axis and −Y-axis directions, respectively. A first, second, third and fourth microphones are mounted in the first, second, third and fourth holes, respectively, and the holes are disposed on an XY virtual plane. An X-axis length Lx between an opening end of the first hole and an opening end of the second hole is shorter than a Y-axis length Ly between an opening end of the third hole and an opening end of the fourth hole and/or a Z-axis length Lz of the housing.

### TECHNICAL FIELD

The present invention relates to a microphone array device.

### BACKGROUND ART

With the development of surround technology in recent years, the number of sound channels in surround sound systems tends to increase from basic 5.1 ch to 6.1 ch or 7.1 ch. Furthermore, the number of required channels has increased to 22.2 ch due to diversification and advancement of content using virtual reality (VR), augmented reality (AR), and the like. In general, in surround sound systems, the number of microphones used in surround sound collection increases according to the number of sound channels in the surround sound systems. That is, when the number of sound channels in the surround sound systems increases, the number of microphones required sound collection also increases.

The surround sound system is set so that sound corresponding to each sound channel has different sound pressure levels and/or phases. That is, the surround sound system requires the separation of a sound field of each microphone included in a microphone array device used for surround sound collection so that each microphone can collect (pick up) sound waves with different sound pressure levels and/or phases.

In general, in surround sound collection, microphones are spaced apart from each other in order to obtain the separation of the microphones. An inter-microphone distance increases as the frequency of sound waves, for which separation is required, decreases (the wavelength of the sound waves increases). Furthermore, when the number of sound channels increases, the number of microphones required for sound collection increases, resulting in an increase in the size of a microphone array device. That is, a trade-off relationship is established between the number of sound channels and the size of the separation, and between the number of sound channels and the size of the microphone array device.

The main purpose of surround sound collection is to collect environmental sound in location shooting and the like. Therefore, an omnidirectional microphone, which does not cause a proximity effect even when the omnidirectional microphone is brought close to a sound source, is suitable for the surround sound collection. However, the omnidirectional microphone collects sound waves from all directions at the same level. Therefore, a distance required for an omnidirectional separation is longer than that for a unidirectional microphone. That is, when the omnidirectional microphone is used for the surround sound collection, the size of the microphone array device increases as compared with the case of using the unidirectional microphone.

As described above, the size of the microphone array device is likely to increase as the separation of microphones is obtained. As a consequence, the microphone array device is poor in portability. Furthermore, since the microphones are individually disposed (for example, at a plurality of locations) according to the number of sound channels, it takes time to set the devices. Therefore, it is necessary to provide a microphone array device that is excellent in portability and requires no time for setting (for example, which can collect sound at one point (singly)) when surround sound collection is performed outdoors such as location shooting.

In the surround sound system, when sound singly collected by the microphone array device (including sound individually collected by each of a plurality of microphones disposed in a certain region) is reproduced, the reproduced sound is heard by listeners with good reproducibility at predetermined listening positions (sweet spots) located approximately equidistant from speakers. However, when a listener's head deviates from the sweet spot, a plurality of sound waves interfere at that moment, that is, the phases of specific frequencies interfere, which may cause a phenomenon (hearing discomfort similar to what is called a comb filter effect) in which the sound levels of the specific frequencies decrease (valley of sound waves occurs) (for example, see Japanese Unexamined Patent Publication No. 2013-57906 and Japanese Patent Application Laid-open No. 2016-119574). This sound wave interference is likely to occur when a listener's head deviates laterally from the sweet spot, especially in surround sound systems in which speakers are disposed on the front and rear sides of the listener (for example, 5.1 ch, 7.1 ch, and 22.2 ch). As a consequence, the reproducibility of reproduced sound is reduced.

Such sound wave interference is a unique phenomenon that occurs when sound is singly collected by a microphone array device having a predetermined size (for example, within about 1 m in diameter) using an omnidirectional microphone, or when sound is individually collected by each of a plurality of omnidirectional microphones disposed in a predetermined region (for example, a region within about 1 m in diameter). That is, the sound wave interference (reduction of reproducibility) does not occur when sound is collected by the same microphone array device having a sufficient size (for example, a diameter of about 2 m or larger). However, when the microphone array device increases in size, since the volume and weight of the microphone array device increase, the microphone array device is poor in portability. That is, a trade-off relationship is established between the suppression of the sound wave interference and the size (portability) of the microphone array device. In this regard, a microphone array device, which has good portability (small size and light weight) and suppresses sound wave interference, is required.

### SUMMARY OF INVENTION

### Technical Problem

An object of the present invention is to solve the problem described above and to provide a microphone array device that has good portability and suppresses sound wave interference.

### Solution to Problem

In a microphone array device according to the present invention, an X-axis, a Y-axis, and a Z-axis are three axes orthogonal to each other. An X-axis direction is a direction along the X-axis. AY-axis direction is a direction along the Y-axis. A Z-axis direction is a direction along the Z-axis. The microphone array device according to the present invention includes a plurality of microphones and a housing that accommodates the microphones. The housing includes a plurality of mounting holes in which the microphones are mounted, respectively. The microphones include a first microphone, a second microphone, a third microphone, and a fourth microphone that are disposed on an XY virtual plane extending along each of the X-axis direction and the Y-axis direction. The mounting holes are disposed on the XY virtual plane and include, when viewed from the Z-axis direction, a first mounting hole opened to an end surface of the housing in a +X-axis direction and in which the first microphone is mounted, a second mounting hole opened to an end surface of the housing in a −X-axis direction and in which the second microphone is mounted, a third mounting hole opened to an end surface of the housing in a +Y-axis direction and in which the third microphone is mounted, and a fourth mounting hole opened to an end surface of the housing in a −Y-axis direction and in which the fourth microphone is mounted. An X-axis length between an opening end of the first mounting hole and an opening end of the second mounting hole in the X-axis direction is shorter than a Y-axis length between an opening end of the third mounting hole and an opening end of the fourth mounting hole in the Y-axis direction and/or a Z-axis length of the housing in the Z-axis direction.

### Advantageous Effects of the Invention

A microphone array device according to the present invention has good portability and suppresses sound wave interference.

### BRIEF DESCRIPTION OF DRAWINGS

FIG. 1 is a perspective view illustrating an embodiment of a microphone array device according to the present invention.

FIG. 2 is a side view of the microphone array device in FIG. 1.

FIG. 3 is a schematic sectional view of the microphone array device taken along line A-A in FIG. 2.

FIG. 4 is a schematic sectional view of the microphone array device taken along line B-B in FIG. 2.

FIG. 5 is a schematic sectional view of the microphone array device taken along line C-C in FIG. 4.

FIG. 6 is a plan view of the microphone array device in FIG. 1.

FIG. 7 is an enlarged schematic sectional view of the microphone array device in FIG. 3.

FIG. 8 is a schematic diagram for explaining a diffraction effect of sound waves due to surface differences.

FIG. 9 is a graph illustrating the frequency characteristics of a single microphone taken out from a housing included in the microphone array device in FIG. 1.

FIG. 10 is a graph illustrating the frequency characteristics of the single microphone in FIG. 9 accommodated in the housing included in the microphone array device in FIG. 1.

FIG. 11 is a perspective view illustrating another embodiment of a microphone array device according to the present invention.

FIG. 12 is a side view of the microphone array device in FIG. 11.

FIG. 13 is a schematic sectional view of the microphone array device taken along line D-D in FIG. 12.

FIG. 14 is a schematic sectional view of the microphone array device taken along line E-E in FIG. 12.

FIG. 15 is a plan view of the microphone array device in FIG. 11.

### DESCRIPTION OF EMBODIMENTS

Hereinafter, embodiments of a microphone array device (hereinafter, referred to as the “present device”) according to the present invention will now be described with reference to the attached drawings. In each drawing, the same members and components are designated by the same reference numerals, and redundant description thereof will be omitted.

In the following description, unless otherwise specified, when three axes orthogonal to each other are an X-axis, a Y-axis, and a Z-axis, respectively, the “X-axis direction” is a direction along the X-axis and is a left-right direction in the present embodiment. The “Y-axis direction” is a direction along the Y-axis and is a front-rear direction in the present embodiment. The “Z-axis direction” is a direction along the Z-axis and is a vertical direction in the present embodiment. The “+X-axis direction” is a positive direction in the X-axis direction and denotes a left side in the present embodiment. The “−X-axis direction” is a negative direction in the X-axis direction and denotes a right side in the present embodiment. The “+Y-axis direction” is a positive direction in the Y-axis direction and denotes a front side in the present embodiment. The “−Y-axis direction” is a negative direction in the Y-axis direction and denotes a rear side in the present embodiment. The “+Z-axis direction” is a positive direction in the Z-axis direction and denotes an upward side in the present embodiment. The “−Z-axis direction” is a negative direction in the Z-axis direction and denotes a downward side in the present embodiment. In the present embodiment, the “front side” denotes a direction in which a sound source of target sound desired to be collected by the present device is located with reference to the present device.

In the following description, an “XY plane (section)” is a plane (section) along the X-axis direction and the Y-axis direction, respectively. An “XZ plane (section)” is a plane (section) along the X-axis direction and the Z-axis direction, respectively.

### Microphone Array Device (1)

### Configuration of Microphone Array Device

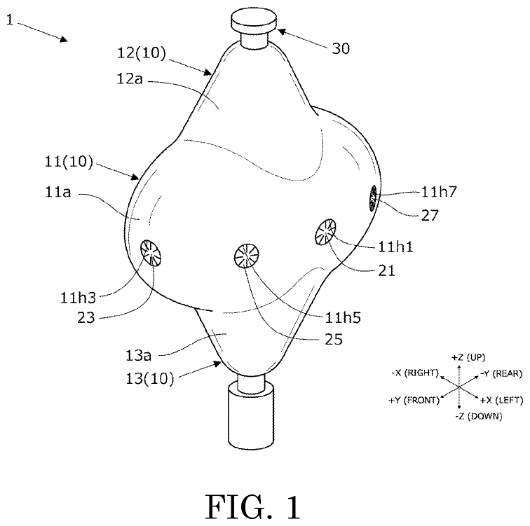

FIG. 1 is a perspective view illustrating an embodiment of the present device.

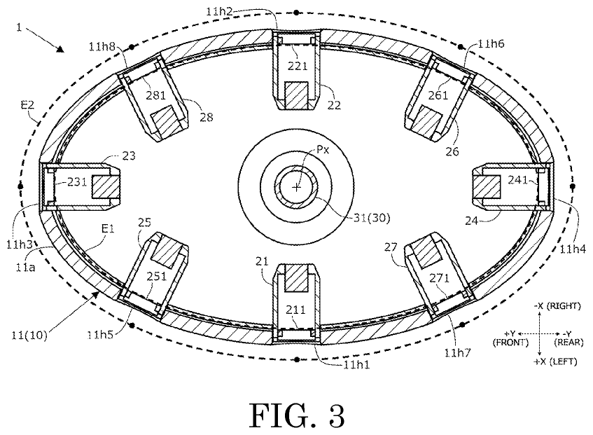

The present device 1 collects sound waves from a plurality of (“eight” in the present embodiment) different directions. The present device 1 includes a housing 10, eight microphones 21, 22, 23, 24, 25, 26, 27, and 28 (see FIG. 3 for the microphones 22, 24, 26, and 28), and a support member 30.

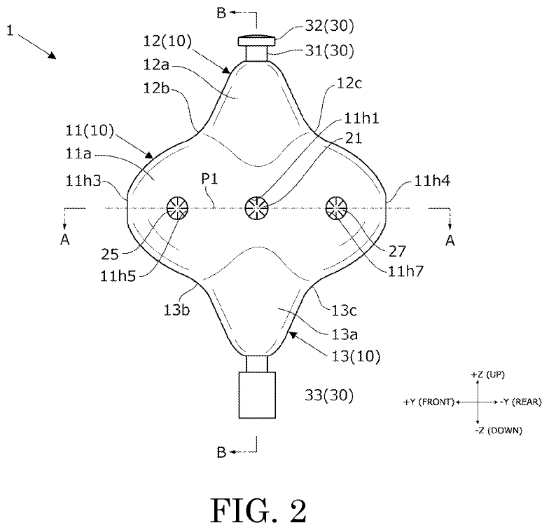

FIG. 2 is a side view of the present device 1 when viewed from the left side (+X-axis direction).

FIG. 3 is a schematic sectional view of the present device 1 taken along line A-A in FIG. 2.

FIG. 3 schematically illustrates the sections of the microphones 21 to 28 for convenience of description.

The housing 10 accommodates the microphones 21 to 28. The housing 10 is made of, for example, a synthetic resin such as ABS. The housing 10 includes a body 11, a first protrusion part 12, and a second protrusion part 13.

The body 11 has an elliptical section having a long axis (not illustrated) along the Y-axis direction (front-rear direction) and a short axis (not illustrated) along the X-axis direction (left-right direction) on an XY virtual plane P1. The body 11 has a hollow spheroidal shape (rugby ball shape) in which the elliptical section is rotated once with the long axis as a rotation axis. The body 11 includes an ellipsoidal surface 11a, and eight mounting holes 11h1, 11h2, 11h3, 11h4, 11h5, 11h6, 11h7, and 11h8.

The ellipsoidal surface 11a forms a surface of the body 11. The ellipsoidal surface 11a among the surfaces on the housing 10 is a spheroidal surface having the long axis along the Y-axis direction (front-rear direction).

The mounting holes 11h1 to 11h8 are circular through holes in which the microphones 21 to 28 are mounted, respectively. The mounting holes 11h1 to 11h8 are disposed at equal intervals on a circumference concentric with a circumference of the body 11 on the XY virtual plane P1. Each of the mounting holes 11h1 to 11h8 penetrates in a direction perpendicular to the ellipsoidal surface 11a (surface) of the body 11.

The “disposing each of the mounting holes 11h1 to 11h8 on the XY virtual plane P1” means that a part of each of the mounting holes 11h1 to 11h8 is disposed on the XY virtual plane P1. In the present embodiment, the center of each of the mounting holes 11h1 to 11h8 is disposed on the XY virtual plane P1.

The mounting hole 11h1 is an example of a first mounting hole in the present invention, the mounting hole 11h2 is an example of a second mounting hole in the present invention, the mounting hole 11h3 is an example of a third mounting hole in the present invention, the mounting hole 11h4 is an example of a fourth mounting hole in the present invention, the mounting hole 11h5 is an example of a fifth mounting hole in the present invention, the mounting hole 11h6 is an example of a sixth mounting hole in the present invention, the mounting hole 11h7 is an example of a seventh mounting hole in the present invention, and the mounting hole 11h8 is an example of an eighth mounting hole in the present invention.

When viewed from the Z-axis direction (vertical direction), each of the mounting holes 11h1 to 11h8 is opened to (disposed on) an end surface of the body 11. Specifically, the mounting hole 11h1 is opened to an end surface of the body 11 on the +X-axis direction side (left side). The mounting hole 11h2 is opened to an end surface of the body 11 on the −X-axis direction side (right side). The mounting hole 11h3 is opened to an end surface of the body 11 on the +Y-axis direction side (front side). The mounting hole 11h4 is opened to an end surface of the body 11 on the −Y-axis direction side (rear side). The mounting hole 11h5 is opened to an end surface of the body 11 between the mounting hole 11h1 and the mounting hole 11h3. The mounting hole 11h6 is opened to an end surface of the body 11 between the mounting hole 11h2 and the mounting hole 11h4. The mounting hole 11h7 is opened to an end surface between the mounting hole 11h1 and the mounting hole 11h4 of the body 11. The mounting hole 11h8 is opened to an end surface between the mounting hole 11h2 and the mounting hole 11h3 of the body 11.

When viewed from the Z-axis direction (vertical direction), the mounting hole 11h1 is disposed line-symmetrically with the mounting hole 11h2 with respect to the Y-axis. The mounting hole 11h3 is disposed line-symmetrically with the mounting hole 11h4 with respect to the X-axis. The mounting hole 11h5 is disposed point-symmetrically with the mounting hole 11h6 with respect to an intersection Px between the long axis and the short axis of the body 11. The mounting hole 11h7 is disposed point-symmetrically with the mounting hole 11h8 with respect to the intersection Px.

A surface of each region between the mounting holes 11h1 to 11h8 on the ellipsoidal surface 11a is a curved surface having the center of curvature located inside the housing 10 (body 11).

The “curved surface” is not a perfect curved surface, and includes a pseudo curved surface composed of a set of a large number of fine polygonal planes (for example, planes composed of hexagons or triangles). In such a case, the size of each plane is equal to or smaller than the size of a circle whose diameter is the length (for example, about 1.7 cm at 20 kHz) of a wavelength of a frequency near the upper limit of the frequency characteristics of the present device 1 (the microphones 21 to 28).

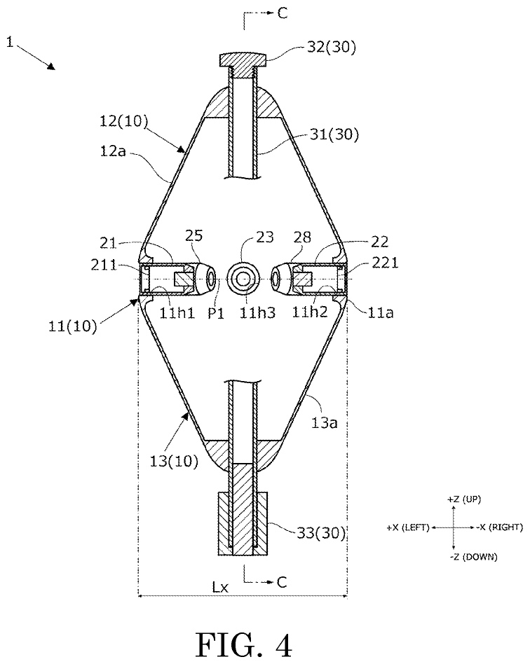

FIG. 4 is a schematic sectional view of the present device 1 taken along line B-B in FIG. 2.

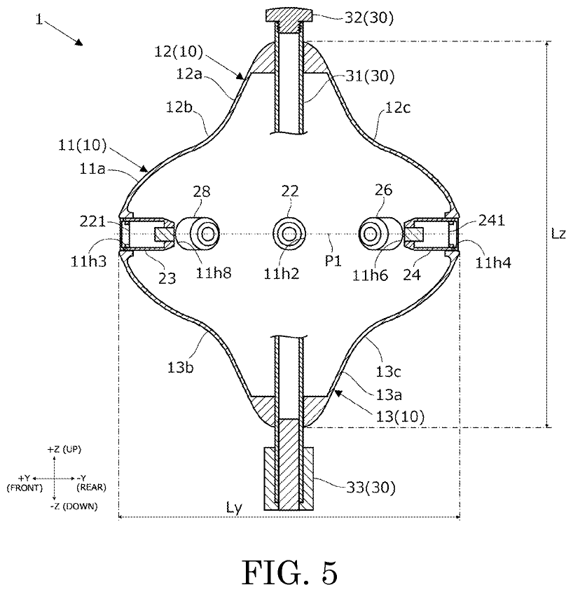

FIG. 5 is a schematic sectional view of the present device 1 taken along line C-C in FIG. 4.

FIG. 4 and FIG. 5 schematically illustrate the sections of the microphones 21 to 26 and 28 for convenience of description.

The first protrusion part 12 contributes to separation to be described below. The first protrusion part 12 protrudes upward from the ellipsoidal surface 11a of the body 11 in a conical shape. The first protrusion part 12 is integrally formed with the body 11. A distal end (upper end) of the first protrusion part 12 has a hemispherical shape. The first protrusion part 12 includes a conical surface 12a and saddle-shaped surfaces 12b and 12c.

The first protrusion part 12 is disposed at the center of the housing 10 (body 11) in each of the X-axis direction (left-right direction) and the Y-axis direction (front-rear direction). In the Z-axis direction (vertical direction), the first protrusion part 12 is disposed above the mounting holes 11h1 to 11h8 (see FIG. 3 for the mounting holes 11h5 and 11h7).

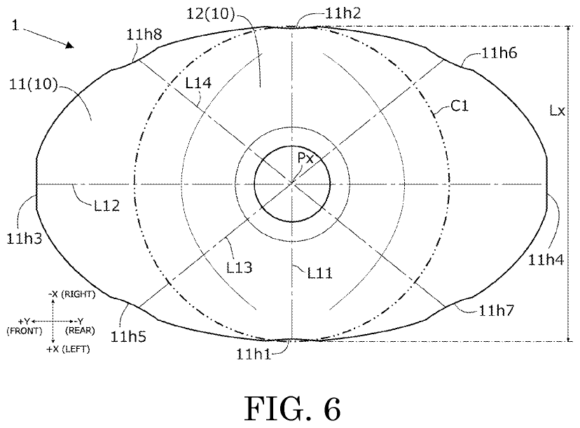

The conical surface 12a is a first conical surface in the present invention. The conical surface 12a forms a part of the surface of the first protrusion part 12. The conical surface 12a is a substantially truncated cone-shaped surface that is tapered upward among the surfaces of the housing 10. In a case where contour lines are drawn when viewed from the top, the conical surface 12a has an elliptical shape in which the contour lines are long in the X-axis direction (left-right direction) (see FIG. 6). As illustrated in FIG. 4, in the XZ sectional view at the center of the housing 10 in the Y-axis direction (front-rear direction), the conical surface 12a is common to a tangent of the ellipsoidal surface 11a of the body 11.

The saddle-shaped surfaces 12b and 12c form a part of the surface of the first protrusion part 12. The saddle-shaped surfaces 12b and 12c are saddle-shaped surfaces that continuously connect the ellipsoidal surface 11a and the conical surface 12a among the surfaces of the housing 10.

The second protrusion part 13 contributes to the separation to be described below. The second protrusion part 13 protrudes downward from the ellipsoidal surface 11a of the body 11 in a conical shape. The second protrusion part 13 is integrally formed with the body 11. A distal end (lower end) of the second protrusion part 13 has a hemispherical shape. The shape of the second protrusion part 13 is the same as that of the first protrusion part 12. The second protrusion part 13 includes a conical surface 13a and saddle-shaped surfaces 13b and 13c.

The second protrusion part 13 is disposed at the center of the housing 10 (body 11) in each of the X-axis direction (left-right direction) and the Y-axis direction (front-rear direction). In the Z-axis direction (vertical direction), the second protrusion part 13 is disposed below the mounting holes 11h1 to 11h8 (see FIG. 3 for the mounting holes 11h5 and 11h7).

The conical surface 13a is a second conical surface in the present invention. The conical surface 13a forms a part of the surface of the second protrusion part 13. The conical surface 13a is a substantially truncated cone-shaped surface that is tapered downward among the surfaces of the housing 10. When contour lines are drawn in a downward view, the conical surface 13a has an elliptical shape in which the contour lines are long in the X-axis direction (left-right direction). As illustrated in FIG. 4, in the XZ sectional view at the center of the housing 10 in the Y-axis direction (front-rear direction), the conical surface 13a is common to the tangent of the ellipsoidal surface 11a of the body 11.

The saddle-shaped surfaces 13b and 13c form a part of the surface of the second protrusion part 13. The saddle-shaped surfaces 13b and 13c are saddle-shaped surfaces that continuously connect the ellipsoidal surface 11a and the conical surface 13a among the surfaces of the housing 10.

FIG. 6 is a plan view of the present device 1 when viewed from the top.

FIG. 6 illustrates an example of connection lines L11 to L14, which will be described below, with one-dot chain lines. FIG. 6 does not illustrate a termination member 32 to be described below, for convenience of description.

In the present device 1, the length of the housing 10 (body 11) in the Y-axis direction (front-rear direction) is longer than an X-axis length Lx to be described below, which is a diameter of a virtual sphere C1. Furthermore, the length of the housing 10 in the Z-axis direction (vertical direction) is longer than the diameter of the virtual sphere C1 and the length of the body 11. As a consequence, the length of the connection line L11, which connects the mounting holes 11h1 and 11h2 disposed line-symmetrically with respect to the Y-axis on the surface of the housing 10, is longer than ½ of a circumference of the virtual sphere C1. Similarly, the length of the connection line L12, which connects the mounting holes 11h3 and 11h4 on the surface of the housing 10, is longer than ½ of the circumference of the virtual sphere C1. The length of the connection line L13, which connects the mounting holes 11h5 and 11h6 on the surface of the housing 10, is longer than ½ of the circumference of the virtual sphere C1. The length of the connection line L14, which connects the mounting holes 11h7 and 11h8 on the surface of the housing 10, is longer than ½ of the circumference of the virtual sphere C1.

Referring now back to FIG. 4 to FIG. 6, in the housing 10 configured as above, the body 11 has a spheroidal shape that is long in the Y-axis direction (front-rear direction). Furthermore, the first protrusion part 12 protrudes upward from the body 11 and the second protrusion part 13 protrudes downward from the body 11. That is, a length (hereinafter, referred to as the “X-axis length Lx”) between an opening end of the mounting hole 11h1 and an opening end of the mounting hole 11h2 in the X-axis direction (left-right direction) is shorter than a length (hereinafter, referred to as a “Y-axis length Ly”) between an opening end of the mounting hole 11h3 and an opening end of the mounting hole 11h4 in the Y-axis direction (front-rear direction). Furthermore, the X-axis length Lx is shorter than a length (hereinafter, referred to as a “Z-axis length Lz”) of the housing 10 in the Z-axis direction (vertical direction). Moreover, the sectional area of an XZ section of the housing 10 decreases from the center of the housing 10 toward the outside in the Y-axis direction. That is, the sectional area decreases toward the front side from the mounting holes 11h1 and 11h2 and decreases toward the rear side from the mounting holes 11h1 and 11h2.

Referring now back to FIG. 3, the microphones 21 to 28 collect sound waves and generate sound signals corresponding to the sound waves. The microphones 21 to 28 are, for example, condenser type omnidirectional microphones. The microphones 21 to 28 include diaphragms 211, 221, 231, 241, 251, 261, 271, and 281 that vibrate in response to the sound waves, respectively. The microphone 21 is an example of a first microphone in the present invention, the microphone 22 is an example of a second microphone in the present invention, the microphone 23 is an example of a third microphone in the present invention, the microphone 24 is an example of a fourth microphone in the present invention, the microphone 25 is an example of a fifth microphone in the present invention, the microphone 26 is an example of a sixth microphone in the present invention, the microphone 27 is an example of a seventh microphone in the present invention, and the microphone 28 is an example of an eighth microphone in the present invention.

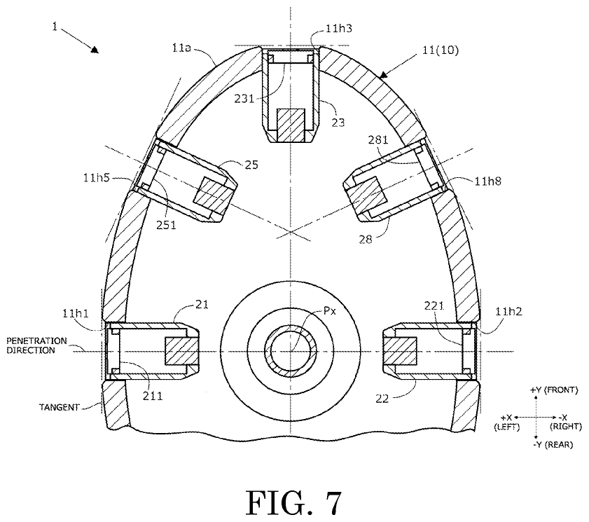

FIG. 7 is an enlarged schematic sectional view of a part of the section of the present device 1 illustrated in FIG. 3.

The microphone 21 is mounted in the mounting hole 11h1 with a sound collection surface facing the outside of the housing 10. As a consequence, the diaphragm 211 of the microphone 21 is disposed inside the ellipsoidal surface 11a and perpendicular to the penetration direction of the mounting hole 11h1.

Referring now back to FIG. 3 and FIG. 7, similarly to the microphone 21, the microphone 22 is mounted in the mounting hole 11h2, the microphone 23 is mounted in the mounting hole 11h3, the microphone 24 is mounted in the mounting hole 11h4, the microphone 25 is mounted in the mounting hole 11h5, the microphone 26 is mounted in the mounting hole 11h6, the microphone 27 is mounted in the mounting hole 11h7, and the microphone 28 is mounted in the mounting hole 11h8. As a consequence, the diaphragms 221, 231, 241, 251, 261, 271, and 281 of the microphones 22 to 28 are also disposed perpendicular to the penetration directions of the corresponding mounting holes 11h2 to 11h8, respectively.

The microphones 21 and 22 are disposed along the X-axis direction (left-right direction), wherein the microphone 21 (diaphragm 211) is directed to the left side and the microphone 22 (diaphragm 221) is directed to the right side. The microphones 23 and 24 are disposed along the Y-axis direction (front-rear direction), wherein the microphone 23 (diaphragm 231) is directed to the front side and the microphone 24 (diaphragm 241) is directed to the rear side. The microphones 25 and 28 are disposed along the X-axis direction (left-right direction), wherein the microphone 25 (diaphragm 251) is directed slightly diagonally forward to the left side and the microphone 28 (diaphragm 281) is directed slightly diagonally forward to the right side. The microphones 26 and 27 are disposed along the X-axis direction (left-right direction), wherein the microphone 26 (diaphragm 261) is directed slightly diagonally rearward to the right side and the microphone 27 (diaphragm 271) is directed slightly diagonally rearward to the left side.

When viewed from the vertical direction, the microphone 21 is disposed line-symmetrically with the microphone 22 with respect to the Y-axis. The microphone 23 is disposed line-symmetrically with the microphone 24 with respect to the X-axis. The microphone 25 is disposed point-symmetrically with the microphone 26 with respect to the intersection Px. The microphone 27 is disposed point-symmetrically with the microphone 28 with respect to the intersection Px.

The microphones 21 to 28 disposed as above are disposed at equal intervals on the circumference concentric with the circumference of the body 11 on the XY virtual plane P1 (see FIG. 4 and FIG. 5). As a consequence, when viewed from the vertical direction, the centers of the diaphragms 221, 231, 241, 251, 261, 271, and 281 are disposed at equal intervals on a virtual ellipse E1 (that is, on the circumference concentric with the circumference of the body 11) inside the ellipsoidal surface 11a. Consequently, when viewed from the vertical direction, positions (to be described below: indicated by “•” in FIG. 3) of acoustic terminals corresponding to the respective microphones 21 to 28 are evenly spaced on a virtual ellipse E2 (that is, on the circumference concentric with the circumference of the body 11) outside the ellipsoidal surface 11a. The “virtual ellipses E1 and E2” are ellipses having a shape similar to the ellipsoidal surface 11a when viewed from the vertical direction.

Here, the “disposing the microphones 21 to 28 on the XY virtual plane P1” means that a part of each of the microphones 21 to 28 is disposed on the same plane which is the XY virtual plane P1. In the present embodiment, the center (sound collection axis) of each of the diaphragms 211, 221, 231, 241, 251, 261, 271, and 281 is disposed on the XY virtual plane P1.

The “acoustic terminal” corresponds to the position of air that applies sound pressure to each of the diaphragms 221, 231, 241, 251, 261, 271, and 281, in other words, the central position of air that moves simultaneously with the diaphragms 221, 231, 241, 251, 261, 271, and 281.

Referring now back to FIG. 3 and FIG. 4, the support member 30 is a connection part in the present invention. The support member 30 can support the housing 10 and connect the present device 1 to an external device (for example, another microphone array device or a member that supports the present device 1). The support member 30 includes a pipe member 31, the termination member 32, and a connection member 33.

The pipe member 31 is, for example, a straight pipe made of a metal such as an aluminum alloy. A female screw is formed on an inner peripheral surface of an upper end of the pipe member 31. The pipe member 31 is mounted into the housing 10 by penetrating the center of each of the first protrusion part 12 and the second protrusion part 13 of the housing 10 in the Z-axis direction (vertical direction). As a consequence, the pipe member 31 is disposed at the center of the housing 10 in each of the X-axis direction (left-right direction) and the Y-axis direction (front-rear direction).

Note that an upper end of the first protrusion part and a lower end of the second protrusion part may be formed of an elastic body such as rubber, for example. In such a case, the pipe member penetrates the elastic body. According to such a configuration, for example, vibration from the member that supports the present device 1 is absorbed by the elastic body.

The termination member 32 serves as a lid at the upper end of the pipe member 31. The termination member 32 includes a male screw corresponding to the female screw of the pipe member 31. The termination member 32 is attached to the upper end of the pipe member 31.

The connection member 33 includes, for example, a cylindrical member, and is attached to an outer peripheral surface of a lower end of the pipe member 31.

### Operation (1) of Microphone Array Device

The operation of the present device 1 will now be described with reference to FIG. 3 to FIG. 5.

The present device 1 is a microphone array device that collects sound waves with the eight microphones 21 to 28. The microphones 21 to 28 are accommodated in one housing 10 and are directed in eight directions. That is, the present device 1 can singly collect sound waves from eight directions: front side, slightly diagonally forward to the left side, left side, slightly diagonally rearward to the left side, rear side, slightly diagonally rearward to the right side, right side, and slightly diagonally forward to the right side.

As described above, the directivity of the microphones 21 to 28 is omnidirectional. Therefore, when distances among the microphones 21 to 28 are brought close to each other (for example, within about 1 m in diameter), sound fields of the microphones 21 to 28 overlap. Therefore, a difference is less likely to occur in the wavelengths and arrival times of sound waves collected by the microphones 21 to 28. As a consequence, the separation of the sound fields of the microphones 21 to 28 is difficult.

However, in the present device 1, the microphones 21 to 28 are accommodated in the body 11 (housing 10) having a surface formed of a curved surface (ellipsoidal surface 11a). That is, each of the microphones 21 to 28 is covered with the body 11 in a direction other than the front. Therefore, the distance of sound waves reaching each of the microphones 21 to 28 from the direction other than the front is longer than that in a case where the microphones 21 to 28 are not accommodated. That is, a difference occurs in the arrival times of sound waves from each direction to each of the microphones 21 to 28. Furthermore, the body 11 is formed of a curved surface. Consequently, disturbance of the frequency characteristics of each of the microphones 21 to 28 accommodated in the body 11 due to a diffraction effect by the ellipsoidal surface 11a is suppressed, and directivity is generated in the microphones 21 to 28. As a consequence, the separation of each of the microphones 21 to 28 is obtained.

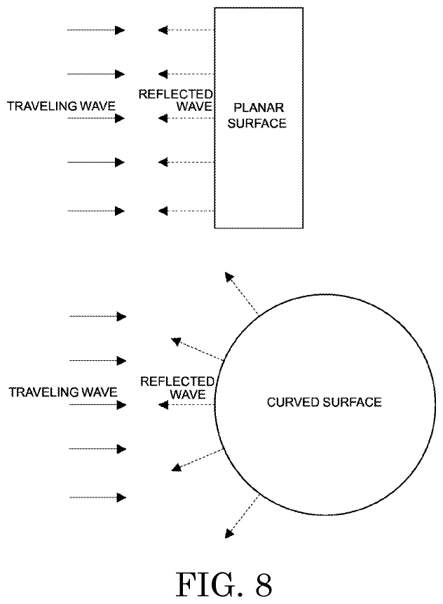

FIG. 8 is a schematic diagram for explaining a diffraction effect of sound waves due to surface differences.

FIG. 8 illustrates a state in which sound waves are reflected off a planar surface and a state in which sound waves are reflected off a curved surface. As illustrated in FIG. 8, when the sound waves are reflected off the planar surface, the sound waves (reflected waves) reflected off the surface are reflected in a direction opposite to a traveling direction. Therefore, the reflected waves are likely to interfere with the sound waves (traveling waves) traveling on the surface. That is, the waveform of the traveling waves is likely to be disturbed. By contrast, when the sound waves are reflected off the curved surface, the sound waves are reflected in all directions. Therefore, the reflected waves are less likely to interfere with the traveling waves. That is, the waveform of the traveling waves is less likely to be disturbed. Consequently, by the housing 10 including a curved surface, the frequency characteristics of each of the microphones 21 to 28 (see FIG. 3) are smooth characteristics in which large disturbance is less likely to occur.

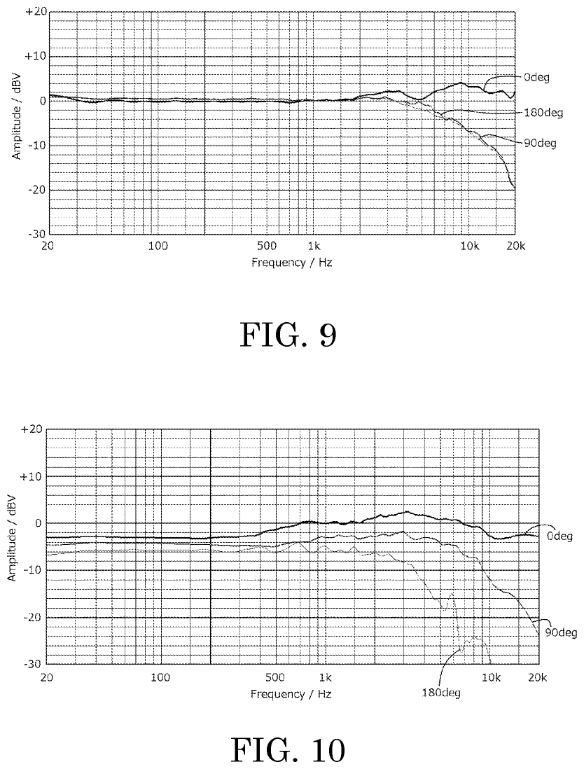

FIG. 9 is a graph illustrating the frequency characteristics of one microphone taken out from the housing 10, here, the single microphone 21.

FIG. 10 is a graph illustrating the frequency characteristics of the microphone in FIG. 9 accommodated in the housing 10, here, the single microphone 21.

Comparing the graph of FIG. 9 with the graph of FIG. 10, the frequency characteristics of the microphone 21 are changed according to whether the microphone 21 is accommodated in the housing 10. That is, when the microphone 21 is accommodated in the housing 10, the microphone 21 has directivity. Consequently, by attaching the microphones 21 to 28 to the housing 10, the microphones 21 to 28 each have directivity.

Referring now back to FIG. 3 to FIG. 5, in the present device 1, since the housing 10 includes the first protrusion part 12 and the second protrusion part 13, the housing 10 becomes larger in the up-down direction. As a consequence, particularly, the length of the surface of the housing 10 between the microphones 21 and 22, between the microphones 23 and 24, between the microphones 25 and 26, and between the microphones 27 and 28, which are point-symmetric with respect to the intersection Px (for example, the lengths of the connection lines L11 to L14 (see FIG. 6)), is longer than a length in a state of only the body 11 (state without the first protrusion part 12 and the second protrusion part 13). Furthermore, the length between the microphones 25 and 27, and between the microphones 26 and 28, which are line-symmetric with respect to the X-axis, and the length between the microphones 25 and 28, and between the microphones 26 and 27, which are line-symmetric with respect to the Y-axis, increase along the shape of the ellipsoidal surface 11a. Consequently, more differences occur in the arrival times of sound waves from the aforementioned directions to the microphones 21 to 28. That is, since the present device 1 includes the body 11 having a spheroidal shape and the first and second protrusion parts 12 and 13 having a conical shape, better separation of the microphones 21 to 28 is obtained as compared with the state of only the body 11. As a consequence, the present device 1 reduces a frequency band in which the directivity of each of the microphones 21 to 28 is obtained.

Here, when each of the microphones 21 to 28 with separation improved by the housing 10 collects sound waves from a single sound source, sound waves from each speaker of the surround sound system reach a listening position with slightly different phases (sound collection timings) and sound pressure levels. Therefore, sound wave interference, which occurs when a listener's head deviates laterally from the listening position, is suppressed. Consequently, the reduction of reproducibility (hearing discomfort similar to what is called a comb filter effect) due to the sound wave interference when the listener's head deviates laterally from the listening position is suppressed.

Furthermore, the body 11 of the housing 10 has a spheroidal shape that is elongated in the front-rear direction. Therefore, the distance between the microphones 23 and 24 directed in the front-rear direction is longer than that between the microphones 21 and 22 directed in the left-right direction. Consequently, the difference in the arrival times of sound waves to the microphones 23 and 24 is larger than that of the sound waves to the microphones 21 and 22. Therefore, the sound collection timing of the sound waves from the single sound source further deviates between the microphones 21 and 22. That is, for example, when the present device 1 collects the sound waves from a sound source in front, the microphone 21 collects the sound waves at an earlier time and the microphone 22 collects the sound waves at a later time. Therefore, in the surround sound system, when the sound collected by the present device 1 from the single sound source is reproduced, the sound waves from front and rear speakers at the listening position become sound waves collected at different times. That is, the phases of the sound waves from the front and rear speakers are different. As a consequence, when the listener's head deviates laterally from the listening position, the sound waves from the front and rear speakers are less likely to interfere, so that discomfort felt by the listener is further suppressed.

Moreover, in the present device 1, for example, by removing the termination member 32 from the pipe member 31, an external device (for example, another microphone array device (another present device 1)) can be connected to the upper part of the present device 1. Furthermore, in the present device 1, for example, an external device (for example, another microphone array device) can also be connected to the lower part of the pipe member 31. In such a case, in order to provide a distance from the external device, a rod-shaped connection member is connected between the present device 1 and the external device. On the other hand, in the present device 1, for example, an external device (for example, a member that supports the present device 1) can be connected to the connection member 33. That is, for example, a present device group is constructed by connecting two present devices 1 in the vertical direction via the connection member. With this, the present device group can singly collect sound of each of an upper layer and a middle layer of 22.2 ch.

Note that the present device may also be connected to another present device via a member that supports the present device. Furthermore, for example, “three” or more of the present devices may also be vertically connected via a connection member in correspondence to future system expansion.

### CONCLUSION (1)

According to the embodiment described above, the present device 1 includes the housing 10 that accommodates the eight microphones 21 to 28. The housing 10 includes the body 11 having a spheroidal shape that is long in the front-rear direction. That is, in the housing 10, the X-axis length Lx is shorter than the Y-axis length Ly. According to such a configuration, a difference occurs in the sound collection time (timing) between sound waves collected by the microphones 21 and 22 directed in the X-axis direction (left-right direction) and sound waves collected by the microphones 23 and 24 directed in the Y-axis direction (front-rear direction).

Furthermore, the housing 10 includes the first protrusion part 12 and the second protrusion part 13 that protrude from the body 11 in the up-down direction. That is, in the housing 10, the X-axis length Lx is shorter than the Z-axis length Lz. According to such a configuration, particularly, the length of the surface of the housing 10 between the microphones 21 and 22, between the microphones 23 and 24, between the microphones 25 and 26, and between the microphones 27 and 28, which are point-symmetric with respect to the intersection Px is longer than a length in a state of only the body 11. Furthermore, the length between the microphones 25 and 27, and between the microphones 26 and 28, which are line-symmetric with respect to the X-axis, and the length between the microphones 25 and 28, and between the microphones 26 and 27, which are line-symmetric with respect to the Y-axis, increase along the shape of the ellipsoidal surface 11a. As a consequence, as described above, the frequency band, in which the directivity of the microphones 21 to 28 is obtained, is reduced. That is, the present device 1 includes the body 11 having a spheroidal shape and the first and second protrusion parts 12 and 13 having a conical shape, thereby reducing the frequency band in which the directivity of the microphones 21 to 28 is obtained. Therefore, the present device 1 can secure the separation of the microphones 21 to 28. As a consequence, in a state in which distances among the microphones 21 to 28 are brought close to each other, the present device 1 can accommodate the microphones 21 to 28 in the single housing 10. That is, the present device 1 can be made smaller and lighter. Consequently, the present device 1 is excellent in portability and can singly collect surround sound.

As described above, in the present device 1, the separation of each of the microphones 21 to 28 is obtained and a difference occurs in the time for each of the microphones 21 to 28 to collect sound waves. As a consequence, when the sound waves collected by the present device 1 are reproduced in the surround sound system, sound wave interference when a listener's head deviates from a listening position is suppressed. That is, the present device 1 is excellent in portability and can reduce discomfort due to the sound wave interference when the listener's head deviates laterally from the listening position.

Furthermore, according to the embodiment described above, the present device 1 includes the conical surfaces 12a and 13a. In the vertical direction, the conical surface 12a is disposed above the mounting holes 11h1 to 11h8, and the conical surface 13a is disposed below the mounting holes 11h1 to 11h8. According to such a configuration, portions (conical surfaces 12a and 13a) among the surfaces of the housing 10, which are located above and below the mounting holes 11h1 to 11h8, are inclined inward the housing 10 with respect to the mounting holes 11h1 to 11h8. Furthermore, the conical surfaces 12a and 13a are smoothly continuous with portions (curved surfaces), which are adjacent to the mounting holes 11h1 and 11h2, as the tangents of the portions, respectively. As a consequence, the effect of suppressing the disturbance of the frequency characteristics caused by the diffraction effect of the housing 10 is improved, and directivity is generated in the microphones 21 to 28 by the geometric shape of the housing 10 (shape in which a spherical surface protrudes in the front-rear and up-down directions). As a consequence, the present device 1 improves the separation of the microphones 21 to 28.

Moreover, according to the embodiment described above, the body 11 has the ellipsoidal surface 11a, which is a curved surface as a whole, as its own surface. That is, portions adjacent to the mounting holes 11h1 to 11h8 are curved surfaces having the centers of curvature located inside the body 11. Therefore, the frequency band, in which the directivity of the microphones 21 to 28 is obtained, is reduced. As a consequence, the present device 1 further improves the separation of the microphones 21 to 28.

Note that the shape of the body in the present embodiment is not limited to the spheroidal shape. That is, for example, in the body, a front part positioned on the front side of the hole (or a rear part positioned on the rear side of the hole) disposed at left and right ends may be formed of a half body of a spheroid, and the rear part (or the front part) may be formed of a half body of a sphere. That is, in the body, the shapes of the front part and the rear part may be different.

Furthermore, the shape of the body in the present embodiment may be a shape having a cylindrical region in a center in the front-rear direction, that is, a shape having an oval (running track shaped) section on the XY virtual plane.

Moreover, the surface of the body in the present embodiment may not be a perfect curved surface, and may be a pseudo curved surface composed of a set of a large number of fine polygonal planes. In such a configuration, the size of each plane is equal to or smaller than the size of a circle whose diameter is the length of a wavelength of a frequency near the upper limit of the frequency characteristics of the present device (microphone).

Moreover, each of the first protrusion part and the second protrusion part in the present embodiment may also be configured separately from the body. That is, for example, each of the first protrusion part and the second protrusion part may also be attachable to and detachable from the body. That is, the conical surface may also be attachable to and detachable from a part (elliptical surface) of the housing. In such a configuration, the separation of the microphone according to the shape of each of the first protrusion part and the second protrusion part attached to the body is obtained.

Moreover, in the present embodiment, the shape of the first protrusion part may also be different from that of the second protrusion part. That is, for example, in the vertical direction, the length of the first protrusion part may also be longer or shorter than that of the second protrusion part. Furthermore, for example, the first protrusion part may also have a truncated cone shape and the second protrusion part may also have a conical shape. In such a configuration, the separation of the microphone according to the shapes of the first protrusion part and the second protrusion part is obtained.

Moreover, each of the first protrusion part and the second protrusion part in the present embodiment may have no saddle-shaped surface.

Moreover, the X-axis length in the housing in the present embodiment may also be longer than the Y-axis length.

Moreover, the housing in the present embodiment may not include both or one of the first protrusion part and the second protrusion part.

Moreover, the microphone in the present embodiment may also be disposed on the top part of the first protrusion part. In such a case, the microphone disposed on the top part is disposed upward. In such a configuration, a distance between the microphone disposed on the top part of the first protrusion part and a microphone disposed on the XY virtual plane is secured by the first protrusion part.

Moreover, among the eight mounting holes in the present embodiment, when four mounting holes (mounting holes 11h5 to 11h8), except for the mounting holes opened to the end surfaces of the housing in the front-rear and left-right directions, are symmetrically disposed, the mounting holes may not be disposed at equal intervals with respective mounting holes on both sides thereof. Accordingly, among the eight microphones in the present embodiment, four microphones (microphones 25 to 28), except for microphones disposed in the housing in the front-rear and left-right directions, may not be disposed at equal intervals with respective microphones on both sides thereof.

### Microphone Array Device (2)

Another embodiment (hereinafter, referred to as a “second embodiment”) of the present device will now be described focusing on differences from the aforementioned embodiment (hereinafter, referred to as a “first embodiment”). The present device in the second embodiment is different from the present device in the first embodiment in terms of the shape of a housing. In the following description, members common to the first embodiment are designated by the same reference numerals, description thereof will be omitted.

### Configuration (2) of Microphone Array Device

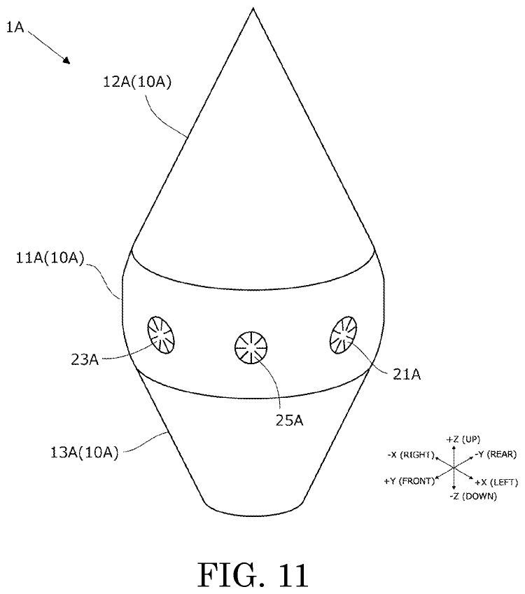

FIG. 11 is a perspective view illustrating the second embodiment of the present device.

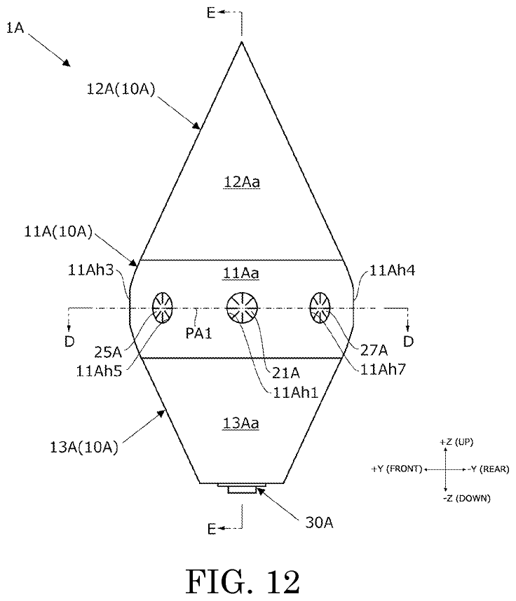

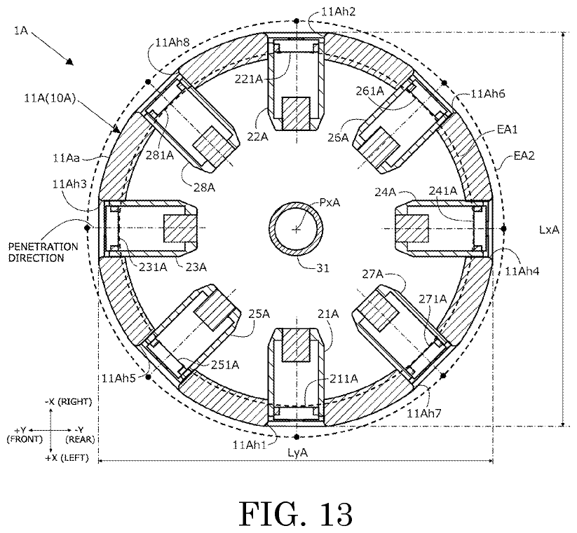

A present device 1A collects sound waves from a plurality of (“eight” in the present embodiment) different directions, and generates a sound signal corresponding to each sound wave. The present device 1A includes a housing 10A, eight microphones 21A, 22A, 23A, 24A, 25A, 26A, 27A, and 28A (see FIG. 13 for the microphones 22A, 24A, 26A, 27A, and 28A), and a support member 30A (see FIG. 12).

FIG. 12 is a side view of the present device 1A when viewed from the left side.

FIG. 13 is a schematic sectional view of the present device 1A taken along line D-D in FIG. 12.

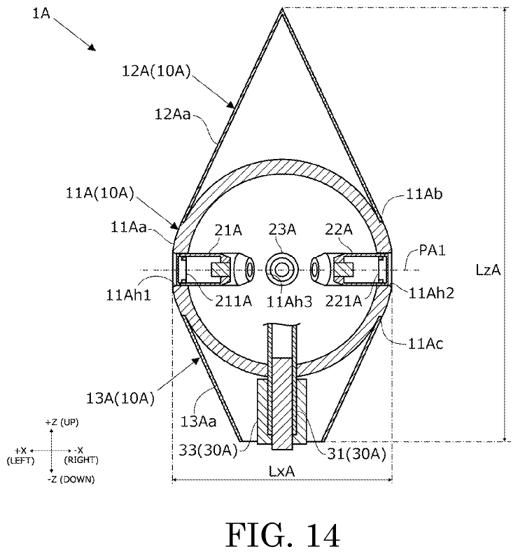

FIG. 14 is a schematic sectional view of the present device 1A taken along line E-E in FIG. 12.

The housing 10A accommodates the microphones 21A to 28A. The housing 10A is made of, for example, a synthetic resin such as ABS. The housing 10A includes a body 11A, a first protrusion part 12A, and a second protrusion part 13A.

The body 11A has a hollow spherical shape having a circular section on an XY virtual plane PAL The body 11A includes a spherical surface 11Aa, and eight mounting holes 11Ah1, 11Ah2, 11Ah3, 11Ah4, 11Ah5, 11Ah6, 11Ah7, and 11Ah8. The spherical surface 11Aa forms a surface of the body 11A.

The mounting holes 11Ah1 to 11Ah8 are circular through holes in which the microphones 21A to 28A are mounted, respectively. The mounting holes 11Ah1 to 11Ah8 are disposed at equal intervals on a circumference concentric with a circumference of the body 11A on the XY virtual plane PAL Each of the mounting holes 11Ah1 to 11Ah8 penetrates in a direction perpendicular to the ellipsoidal surface 11Aa (surface) of the body 11A.

The “disposing each of the mounting holes 11Ah1 to 11Ah8 on the XY virtual plane PA1” means that a part of each of the mounting holes 11Ah1 to 11Ah8 is disposed on the same plane called the XY virtual plane PAL In the present embodiment, the center of each of the mounting holes 11Ah1 to 11Ah8 is disposed on the XY virtual plane PAL

The mounting hole 11hA1 is an example of a first mounting hole in the present invention, the mounting hole 11Ah2 is an example of a second mounting hole in the present invention, the mounting hole 11Ah3 is an example of a third mounting hole in the present invention, the mounting hole 11Ah4 is an example of a fourth mounting hole in the present invention, the mounting hole 11Ah5 is an example of a fifth mounting hole in the present invention, the mounting hole 11Ah6 is an example of a sixth mounting hole in the present invention, the mounting hole 11Ah7 is an example of a seventh mounting hole in the present invention, and the mounting hole 11Ah8 is an example of an eighth mounting hole in the present invention.

When viewed from the Z-axis direction (vertical direction), each of the mounting holes 11Ah1 to 11Ah8 is opened to (disposed on) an end surface of the body 11A. Specifically, the mounting hole 11Ah1 is opened to a left end surface of the body 11A. The mounting hole 11Ah2 is opened to a right end surface of the body 11A. The mounting hole 11Ah3 is opened to a front end surface of the body 11. The mounting hole 11Ah4 is opened to a rear end surface of the body 11A. The mounting hole 11Ah5 is opened to an end surface between the mounting hole 11Ah1 and the mounting hole 11Ah3 of the body 11A. The mounting hole 11Ah6 is opened to an end surface between the mounting hole 11Ah2 and the mounting hole 11Ah4 of the body 11A. The mounting hole 11Ah7 is opened to an end surface between the mounting hole 11Ah1 and the mounting hole 11Ah4 of the body 11A. The mounting hole 11Ah8 is opened to an end surface between the mounting hole 11Ah2 and the mounting hole 11Ah3 of the body 11A. That is, each of the mounting holes 11Ah1 to 11Ah8 is disposed on the circumference concentric with the circumference of the body 11A.

When viewed from the Z-axis direction (vertical direction), any one of the mounting holes 11Ah1 to 11Ah8 is disposed line-symmetrically with the others of the mounting holes 11Ah1 to 11Ah8, which are not adjacent to the any one, with respect to a straight line passing through a center point PxA of the body 11A, or is disposed point-symmetrically with the others with respect to the center point PxA. That is, for example, the mounting hole 11Ah1 is disposed line-symmetrically with the mounting hole 11Ah2 with respect to the Y-axis of the body 11A. The mounting hole 11Ah3 is disposed line-symmetrically with the mounting hole 11Ah4 with respect to the X-axis. The mounting hole 11Ah5 is disposed point-symmetrically with the mounting hole 11Ah6 with respect to the center point PxA, and the mounting hole 11Ah7 is disposed point-symmetrically with the mounting hole 11Ah8 with respect to the center point PxA.

A surface of each region between the mounting holes 11Ah1 to 11Ah8 on the spherical surface 11Aa is a curved surface having the center of curvature located inside the housing 10A (body 11A). Furthermore, a portion of the spherical surface 11Aa adjacent to each of the mounting holes 11Ah1 to 11Ah8 is a curved surface having the corresponding mounting holes 11Ah1 to 11Ah8 as top parts and the center of curvature located inside the housing 10A (body 11A). Annular stepped parts 11Ab and 11Ac are disposed above and below the mounting holes 11Ah1 to 11Ah8 on the spherical surface 11Aa.

The first protrusion part 12A contributes to separation to be described below. The first protrusion part 12A has a hollow conical shape. The first protrusion part 12A is provided separately from the body 11A. That is, the first protrusion part 12A is attachable to and detachable from the body 11A. The first protrusion part 12A is attached to the body 11A so as to cover an upper part of the body 11A. A lower end of the first protrusion part 12A abuts the stepped part 11Ab of the spherical surface 11Aa. When viewed from the top, the first protrusion part 12A is disposed at the center of the housing 10A (body 11A). In the Z-axis direction (vertical direction), the first protrusion part 12A is disposed above the mounting holes 11Ah1 to 11Ah8. As a consequence, the first protrusion part 12A protrudes upward from the spherical surface 11Aa of the body 11A in a conical shape. The first protrusion part 12A includes a conical surface 12Aa that forms the surface of the first protrusion part 12A. The conical surface 12Aa is a first conical surface in the present invention.

The second protrusion part 13A contributes to separation to be described below. The second protrusion part 13A has an inverted truncated-cone tubular shape. That is, the shape of the second protrusion part 13A is different from that of the first protrusion part 12A. The second protrusion part 13A is provided separately from the body 11A. That is, the second protrusion part 13A is attachable to and detachable from the body 11A. The second protrusion part 13A is attached to the body 11A so as to cover a lower part of the body 11A. An upper end of the second protrusion part 13A abuts the stepped part 11Ac of the spherical surface 11Aa. When viewed from the bottom, the second protrusion part 13A is disposed at the center of the housing 10A (body 11A). In the vertical direction, the second protrusion part 13A is disposed below the mounting holes 11Ah1 to 11Ah8. As a consequence, the second protrusion part 13A protrudes downward from the spherical surface 11Aa of the body 11A in a truncated cone shape. The second protrusion part 13A includes a conical surface 13Aa that forms the surface of the second protrusion part 13A. The conical surface 13Aa is a second conical surface in the present invention. When a lower end of the second protrusion part 13A is extended to form the second protrusion part 13A into a conical shape, a straight line connecting the vertices of the first protrusion part 12A and the second protrusion part 13A passes through the center point PxA of the body 11A.

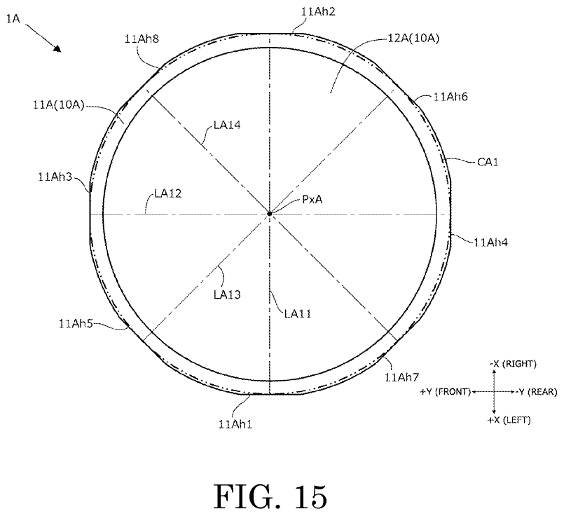

FIG. 15 is a plan view of the present device 1A when viewed from the top.

FIG. 15 illustrates an example of connection lines LA11 to LA14, which will be described below, with one-dot chain lines.

In the present device 1A, each of an upper part (first protrusion part 12A) and a lower part (second protrusion part 13A (see FIG. 13)) of the housing 10A protrudes in the vertical direction from the body 11. As a consequence, the length of the connection line LA11 connecting the mounting holes 11Ah1 and 11Ah2 disposed point-symmetrically with respect to the center point PxA on the surface of the housing 10A is longer than ½ of the circumference of the body 11A. Similarly, the length of the connection line LA12 connecting the mounting holes 11Ah3 and 11Ah4 on the surface of the housing 10A is longer than ½ of the circumference of the body 11A. The length of the connection line LA13 connecting the mounting holes 11Ah5 and 11Ah6 on the surface of the housing 10A is longer than ½ of the circumference of the body 11A. The length of the connection line LA14 connecting the mounting holes 11Ah7 and 11Ah8 on the surface of the housing 10A is longer than ½ of the circumference of the body 11A. Here, the circumference of the body 11A is substantially the same as the circumference of a virtual sphere CA1 having a diameter of an X-axis length LxA (see FIG. 14), which will be described below.

Referring now back to FIG. 12 to FIG. 14, in the housing 10A configured as above, the body 11A has a spherical shape. Furthermore, the first protrusion part 12A protrudes upward from the body 11A and the second protrusion part 13A protrudes downward from the body 11A. That is, a length (hereinafter, referred to as the “X-axis length LxA”) between an opening end of the mounting hole 11Ah1 and an opening end of the mounting hole 11Ah2 in the left-right direction is the same as a length (hereinafter, referred to as a “Y-axis length LyA”) between an opening end of the mounting hole 11Ah3 and an opening end of the mounting hole 11Ah4 in the front-rear direction. Furthermore, the X-axis length LxA is shorter than a length (hereinafter, referred to as a “Z-axis length LzA”) of the housing 10A in the Z-axis direction. Moreover, the sectional area of an XZ section of the housing 10A decreases toward the front side from the mounting holes 11Ah1 and 11Ah2 and decreases toward the rear side from the mounting holes 11Ah1 and 11Ah2.

The configuration of the microphones 21A to 28A is the same as the configuration of the microphones 21 to 28 of the first embodiment except for the arrangement of the microphones 21A to 28A. That is, the microphones 21A to 28A include diaphragms 211A, 221A, 231A, 241A, 251A, 261A, 271A, and 281A, respectively. The microphone 21A is an example of a first microphone in the present invention, the microphone 22A is an example of a second microphone in the present invention, the microphone 23A is an example of a third microphone in the present invention, the microphone 24A is an example of a fourth microphone in the present invention, the microphone 25A is an example of a fifth microphone in the present invention, the microphone 26A is an example of a sixth microphone in the present invention, the microphone 27A is an example of a seventh microphone in the present invention, and the microphone 28A is an example of an eighth microphone in the present invention.

The microphone 21A is mounted in the mounting hole 11Ah1, the microphone 22A is mounted in the mounting hole 11Ah2, the microphone 23A is mounted in the mounting hole 11Ah3, the microphone 24A is mounted in the mounting hole 11Ah4, the microphone 25A is mounted in the mounting hole 11Ah5, the microphone 26A is mounted in the mounting hole 11Ah6, the microphone 27A is mounted in the mounting hole 11Ah7, and the microphone 28A is mounted in the mounting hole 11Ah8. That is, the microphones 21A to 28A are disposed at equal intervals on the circumference concentric with the circumference of the body 11A on the XY virtual plane PA1 while their sound collection surfaces are directed radially outward the body 11A. As a consequence, the diaphragms 211A, 221A, 231A, 241A, 251A, 261A, 271A, and 281A of the microphones 21A to 28A are also disposed inside the spherical surface 11Aa and perpendicular to the penetration directions of the corresponding mounting holes 11Ah1 to 11Ah8, respectively.

When viewed from the Z-axis direction (vertical direction), any one of the microphones 21A to 28A is disposed line-symmetrically with the others of the microphones 21A to 28A, which are not adjacent to the any one, with respect to a straight line passing through the center point PxA, or is disposed point-symmetrically with the others with respect to the center point PxA. That is, for example, the microphone 21A is disposed line-symmetrically with the microphone 22A with respect to the Y-axis. The microphone 23A is disposed line-symmetrically with the microphone 24A with respect to the X-axis. The microphone 25A is disposed point-symmetrically with the microphone 26A with respect to the center point PxA, and the microphone 27A is disposed point-symmetrically with the microphone 28A with respect to the center point PxA.

The microphones 21A and 22A are disposed along the left-right direction, wherein the microphone 21A is directed to the left side and the microphone 22A is directed to the right side. The microphones 23A and 24A are disposed along the front-rear direction, wherein the microphone 23A is directed to the front side and the microphone 24A is directed to the rear side. The microphones 25A and 28A are disposed along the left-right direction, wherein the microphone 25A is directed diagonally forward to the left side and the microphone 28A is directed diagonally forward to the right side. The microphones 26A and 27A are disposed along the left-right direction, wherein the microphone 26A is directed diagonally rearward to the right side and the microphone 27A is directed diagonally rearward to the left side.

The microphones 21A to 28A disposed as above are disposed at equal intervals on the circumference concentric with the circumference of the body 11A on the XY virtual plane PAL As a consequence, when viewed from the vertical direction, the centers of the diaphragms 221A, 231A, 241A, 251A, 261A, 271A, and 281A are disposed at equal intervals on a virtual circle EA1 (that is, on the circumference concentric with the circumference of the body 11A) inside the spherical surface 11Aa. Consequently, when viewed from the vertical direction, positions (indicated by “•” in FIG. 13) of acoustic terminals corresponding to the respective microphones 21A to 28A are evenly spaced on a virtual circle EA2 (that is, on the circumference concentric with the circumference of the body 11A) outside the spherical surface 11Aa.

Here, the “disposing the microphones 21A to 28A on the XY virtual plane PA1” means that a part of each of the microphones 21A to 28A is disposed on the XY virtual plane PAL In the present embodiment, the center of each of the diaphragms 211A, 221A, 231A, 241A, 251A, 261A, 271A, and 281A is disposed on the XY virtual plane PAL

The support member 30A is a connection part in the present invention. The support member 30A can support the housing 10A and connect the present device 1A to an external device. The support member 30A includes a pipe member 31 and a connection member 33. The pipe member 31 is mounted into the body 11A by penetrating a lower end surface of the body 11A in the vertical direction. When viewed from the bottom, the pipe member 31 is disposed at the center of the body 11A.

### Operation (2) of Microphone Array Device

The operation of the present device 1A will now be described with reference to FIG. 13 to FIG. 15.

When viewed from the vertical direction, the present device 1A is a microphone array device that collects sound waves with the eight microphones 21A to 28A respectively mounted in the mounting holes 11Ah1 to 11Ah8 opened to the end surfaces of the housing 10A in eight directions. The microphones 21A to 28A are accommodated in one housing 10A and are directed in eight directions. That is, the present device 1A can collect sound waves from eight directions at one point: front side, diagonally forward to the left side, left side, diagonally rearward to the left side, rear side, diagonally rearward to the right side, right side, and diagonally forward to the right side.

In the present device 1A, the microphones 21A to 28A are accommodated in the body 11A (housing 10A) having a surface formed of a curved surface (spherical surface 11Aa). That is, each of the microphones 21A to 28A is covered with the body 11A in a direction other than the front. Therefore, the distance of sound waves reaching each of the microphones 21A to 28A from the direction other than the front is longer than that in a case where the microphones 21A to 28A are not accommodated. That is, a difference occurs in the arrival times of sound waves from each direction to each of the microphones 21A to 28A. Furthermore, the body 11A is formed of a curved surface. Consequently, similarly to the present device 1 of the first embodiment, disturbance of the frequency characteristics of each of the microphones 21A to 28A due to a diffraction effect by the spherical surface 11Aa is suppressed, and directivity is generated in the microphones 21A to 28A. As a consequence, the separation of the microphones 21A to 28A is obtained.

In the present device 1A, since the housing 10A includes the first protrusion part 12A and the second protrusion part 13A, the housing 10A becomes larger in the vertical direction. As a consequence, particularly, the length of the surface of the housing 10A between the microphones 21A and 22A, between the microphones 23A and 24A, between the microphones 25A and 26A, and between the microphones 27A and 28A, which are point-symmetric (for example, the lengths of the connection lines LA11 to LA14), is longer than a length in a state of only the body 11A (state without the first protrusion part 12A and the second protrusion part 13A). As a consequence, the present device 1A reduces a frequency band in which the directivity of each of the microphones 21A to 28A is obtained. That is, the present device 1A obtains the separation of the microphones 21A to 28A.

When reproducing sound waves from a single sound source collected by each of the microphones 21A to 28A with separation obtained by the housing 10, sound waves from each speaker of the surround sound system reach a listening position with slightly different times (phases) and sound pressure levels. Therefore, sound wave interference, which occurs when a listener's head deviates from the listening position, is suppressed. Consequently, the reduction of reproducibility (hearing discomfort similar to what is called a comb filter effect) due to the sound wave interference when the listener's head deviates from the listening position is suppressed.

Furthermore, similarly to the present device 1 of the first embodiment, the present device 1A is vertically connectable to an external device (for example, another microphone array device (another present device 1A) or a member that supports the present device 1A) via the support member 30A.

### CONCLUSION (2)

According to the embodiment described above, the present device 1A includes the housing 10A that accommodates the eight microphones 21A to 28A. The housing 10A includes the body 11A having a spherical shape and the first protrusion part 12A and the second protrusion part 13A that protrude in the vertical direction from the body 11A. That is, in the housing 10A, the X-axis length LxA is shorter than the Z-axis length LzA. According to such a configuration, particularly, the length of the surface of the housing 10A between the microphones 21A and 22A, between the microphones 23A and 24A, between the microphones 25A and 26A, and between the microphones 27A and 28A, which are point-symmetric with respect to the center point PxA is longer than a length in a state of only the body 11A. Furthermore, the length between the microphones 25A and 27A, and between the microphones 26A and 28A, which are line-symmetric with respect to the X-axis, and the length between the microphones 25A and 28A, and between the microphones 26A and 27A, which are line-symmetric with respect to the Y-axis, increase along the shape of the spherical surface 11Aa (and a part of the conical surfaces 12Aa and 13Aa). As a consequence, as described above, the frequency band, in which the directivity of the microphones 21A to 28A is obtained, is reduced. That is, the present device 1A includes the body 11A having a spherical shape, the first protrusion part 12A having a conical shape, and the second protrusion part 13A having a truncated-cone shape, thereby reducing the frequency band in which the directivity of the microphones 21A to 28A is obtained. Therefore, the present device 1A can secure the separation of the microphones 21A to 28A. As a consequence, when sound waves collected by the present device 1A are reproduced in the surround sound system, sound wave interference when a listener's head deviates from a listening position is suppressed.

Furthermore, the present device 1A causes the microphones 21A to 28A to have directivity by the housing 10A protruding vertically and improves the separation of the microphones 21A to 28A. Therefore, the present device 1A can accommodate the microphones 21A to 28A in the single housing 10A in a state in which distances among the microphones 21A to 28A are brought close to each other. That is, the present device 1A can be made smaller and lighter. Therefore, the present device 1A is excellent in portability and can singly collect surround sound. That is, the present device 1A is excellent in portability and can suppress the sound wave interference described above.

Furthermore, according to the embodiment described above, the present device 1A includes the conical surfaces 12Aa and 13Aa. In the vertical direction, the conical surface 12Aa is disposed above the mounting holes 11Ah1 to 11Ah8, and the conical surface 13Aa is disposed below the mounting holes 11Ah1 to 11Ah8. According to such a configuration, portions (conical surfaces 12Aa and 13Aa) among the surfaces of the housing 10A, which are located above and below the mounting holes 11Ah1 to 11Ah8, are inclined inward the housing 10A with respect to the mounting holes 11Ah1 to 11Ah8. Furthermore, the conical surfaces 12Aa and 13Aa are smoothly continuous with portions (curved surfaces), which are adjacent to the mounting holes 11Ah1 to 11Ah8, as the tangents of the portions, respectively. As a consequence, even though the conical surfaces 12Aa and 13Aa are disposed close to the mounting holes 11Ah1 to 11Ah8, the effect of suppressing the disturbance of the frequency characteristics caused by the diffraction effect of the housing 10A is improved, and directivity is generated in the microphones 21A to 28A by the geometric shape of the housing 10A (shape in which a spherical surface protrudes in the vertical direction). As a consequence, the present device 1A improves the separation of the microphones 21A to 28A.

Moreover, according to the embodiment described above, the body 11A has the spherical surface 11Aa, which is a curved surface as a whole, as its own surface. That is, portions adjacent to the mounting holes 11Ah1 to 11Ah8 are curved surfaces having the centers of curvature located inside the body 11A. Therefore, the frequency band, in which the directivity of the microphones 21A to 28A is obtained, is reduced. As a consequence, the present device 1A further improves the separation of the microphones 21A to 28A.

Moreover, according to the embodiment described above, the first protrusion part 12A (conical surface 12Aa) and the second protrusion part 13A (conical surface 13Aa) are attachable to and detachable from the body 11A. According to such a configuration, the separation of the microphones 21A to 28A according to the shape of each of the first protrusion part 12A and the second protrusion part 13A attached to the body 11A can be adjusted.

Note that the shape of the body in the present embodiment is not limited to a spherical shape. That is, for example, the body may have a spherical shape flat in the vertical direction (the body may have a circular shape when viewed from the vertical direction or an elliptical shape or oval shape when viewed from the side).

Furthermore, the surface of the body in the present embodiment may not be a perfect curved surface, and may be a pseudo curved surface composed of a set of a large number of fine polygonal planes.

Moreover, each of the first protrusion part and the second protrusion part in the present embodiment may also be integrally configured with the body.

Moreover, in the present embodiment, the shape of the first protrusion part may also be the same as that of the second protrusion part. That is, for example, each of the first protrusion part and the second protrusion part may have a truncated-cone shape or a conical shape.

Moreover, the housing in the present embodiment may not include both or one of the first protrusion part and the second protrusion part.

Moreover, the pipe member in the present embodiment may also protrude upward from the housing by penetrating the upper surface of the body and the first protrusion part.

Moreover, in each of the embodiments described above, the present device 1 (present device 1A) includes the eight microphones 21 to 28 (microphones 21A to 28A). Instead, the present device may also include only four microphones (microphones 21 to 24 or microphones 21A to 24A) disposed in the front, rear, left, and right directions. In such a case, for example, the present device may also process an output signal (sound signal) of each of the four microphones on the basis of a phase difference of sound waves collected by each of the microphones, and virtually generate output signals of the other four microphones (microphones directed diagonally forward to the left side, diagonally forward to the right side, diagonally rearward to the left side, and diagonally rearward to the right side).

1. A microphone array device comprising:
a plurality of microphones; and
a housing that accommodates the microphones, wherein
assuming that three axes orthogonal to each other are an X-axis, a Y-axis, and a Z-axis, a direction along the X-axis is an X-axis direction, a direction along the Y-axis is a Y-axis direction, and a direction along the Z-axis is a Z-axis direction,
the housing includes a plurality of mounting holes in which the respective microphones are mounted,
the microphones include a first microphone, a second microphone, a third microphone, and a fourth microphone, each of which are disposed on an XY virtual plane extending along each of the X-axis direction and the Y-axis direction,
the mounting holes are disposed on the XY virtual plane and include, when viewed from the Z-axis direction,
a first mounting hole opened to an end surface of the housing in a +X-axis direction and in which the first microphone is mounted,
a second mounting hole opened to an end surface of the housing in a −X-axis direction and in which the second microphone is mounted,
a third mounting hole opened to an end surface of the housing in a +Y-axis direction and in which the third microphone is mounted, and
a fourth mounting hole opened to an end surface of the housing in a −Y-axis direction and in which the fourth microphone is mounted, and
an X-axis length between an opening end of the first mounting hole and an opening end of the second mounting hole in the X-axis direction is shorter than a Y-axis length between an opening end of the third mounting hole and an opening end of the fourth mounting hole in the Y-axis direction and/or a Z-axis length of the housing in the Z-axis direction.

2. The microphone array device according to claim 1, wherein a length of a connection line connecting the first mounting hole and the second mounting hole on a surface of the housing, is ½ or longer of a length of a circumference of a virtual sphere having a diameter of the X-axis length.

3. The microphone array device according to claim 1, wherein a sectional area of an XZ section of the housing parallel to each of the X-axis direction and the Z-axis direction decreases toward the +Y-axis direction from each of the first mounting hole and the second mounting hole.

4. The microphone array device according to claim 3, wherein the sectional area of the XZ section decreases toward the −Y-axis direction from each of the first mounting hole and the second mounting hole.

5. The microphone array device according to claim 4, wherein the housing includes a spheroidal ellipsoidal surface having a long axis along the Y-axis on the XY virtual plane.

6. The microphone array device according to claim 1, wherein the housing includes a first conical surface that is tapered toward a +Z-axis direction and/or a second conical surface that is tapered toward a −Z-axis direction.

7. The microphone array device according to claim 6, wherein
each of the first conical surface and the second conical surface is disposed at a center of the housing in each of the X-axis direction and the Y-axis direction, and
in the Z-axis direction, the first conical surface is disposed in the +Z-axis direction of each mounting hole, and the second conical surface is disposed in the −Z-axis direction of each mounting hole.

8. The microphone array device according to claim 6, wherein each of the first conical surface and the second conical surface is attachable to and detachable from a part of the housing.

9. The microphone array device according to claim 6, wherein a shape of the first conical surface is the same as a shape of the second conical surface.

10. The microphone array device according to claim 6, wherein a shape of the first conical surface is different from a shape of the second conical surface.

11. The microphone array device according to claim 1, wherein a surface of each region between the mounting holes on the housing is a curved surface having a center of curvature located inside the housing in penetration directions of the adjacent mounting holes.

12. The microphone array device according to claim 1, wherein
the first microphone is directed in the +X-axis direction,
the second microphone is directed in the −X-axis direction,
the third microphone is directed in the +Y-axis direction, and
the fourth microphone is directed in the −Y-axis direction.

13. The microphone array device according to claim 12, wherein
the microphones include a fifth microphone, a sixth microphone, a seventh microphone, and an eighth microphone, each of which are disposed on the XY virtual plane, and
the mounting holes include, when viewed from the Z-axis direction,
a fifth mounting hole opened to an end surface between the first mounting hole and the third mounting hole of the housing and in which the fifth microphone is mounted,
a sixth mounting hole opened to an end surface between the second mounting hole and the fourth mounting hole of the housing and in which the sixth microphone is mounted,
a seventh mounting hole opened to an end surface between the first mounting hole and the fourth mounting hole of the housing and in which the seventh microphone is mounted, and
an eighth mounting hole opened to an end surface between the second mounting hole and the third mounting hole of the housing and in which the eighth microphone is mounted.

14. The microphone array device according to claim 13, wherein the microphones are disposed on a circumference concentric with a circumference of the housing.

15. The microphone array device according to claim 14, wherein the microphones are disposed on the circumference at equal intervals.

16. The microphone array device according to claim 14, wherein acoustic terminals corresponding to the microphones are located on the circumference concentric with the circumference.

17. The microphone array device according to any one of claim 12, wherein
the microphones include respective diaphragms that vibrate in response to a sound wave,
each of the mounting holes penetrates in a direction perpendicular to a surface of the housing, and
each of the diaphragms is disposed perpendicular to a penetration direction of corresponding one of the mounting holes.
